(19) United States
(12) Patent Application Publication
(10) Pub. No.: US 2020/0102742 A1
(43) Pub. Date: Apr. 2, 2020

(54) ACOUSTIC CEILING PANEL

(71) Applicant: Rockwool International A/S, Hedehusene (DK)

(72) Inventors: Chris Albert Augustinas, Maaseik (BE); Brett Christeon, Frankfort, IL (US); Erling Lennart Hansen, Virum (DK); Thomas Hjelmgaard, Fredensborg (DK); Magdalena Hubertina Maria Koop, Selfkant (DE); Lars Naerum, Hellerup (DK); Povl Nissen, Olstykke (DK); Amish Shah, Chicago, IL (US); Thomas Smith, Palos Park, IL (US)

(21) Appl. No.: 16/544,081

(22) Filed: Aug. 19, 2019

Related U.S. Application Data
(60) Provisional application No. 62/738,300, filed on Sep. 28, 2018.

(51) Int. Cl. E04B 9/00; E04B 1/86; B32B 19/06

(52) U.S. Cl. CPC E04B 9/001; B29C 43/003; B32B 19/06; E04B 1/86

(57) ABSTRACT

An acoustical ceiling panel is provided having a core with a front face and a back face composed of air laid mineral fibers and an aqueous binder. The aqueous binder includes a first component in the form of one or more carbohydrates, and a second component in the form of one or more compounds selected from sulfamic acid, derivatives of sulfamic acid, and any salts thereof, ammonia and hypophosphorous acid. A formaldehyde-free first fleece having a thickness is secured to the front face of the core by powdered adhesive and a formaldehyde-free second fleece having a thickness is secured to the back face of the core by the aqueous binder, with the thickness of the first fleece being greater than the thickness of the second fleece. Paint is applied to the first fleece. The acoustical ceiling panel has formaldehyde emissions of below 8 μg/m²/h of formaldehyde, preferably below 5 μg/m²/h, most preferably below 3 μg/m²/h, in accordance with ISO 16000 for testing aldehyde emissions.

### BACKGROUND

The present application relates to an acoustic ceiling panel and, more particularly to an acoustic ceiling panel comprising a mineral fiber matt with fleeces on its faces having improved environmental characteristics without compromise of performance and economic characteristics.

In the development of building products, environmental characteristics are becoming an increasingly important factor. Oftentimes, governmental regulations and building codes dictate requirements as to the environmental impact of the building product through its entire life cycle, from manufacture to use and disposal. With respect to acoustic ceiling panels, this relates to emissions, during both the manufacture of the panels and after their installation, of potentially harmful volatile substances, such as formaldehyde, phenols and ammonia.

Sustainability is also important consideration with respect to the development of building products, namely, the ability to make the building products from recycled materials and to also be able to recycle the products at the end of their useful life.

However important environmental and sustainability criteria are in the development of building products, satisfaction of these criteria cannot result in products with diminished performance characteristics. For ceiling panels, this includes characteristics such as acoustical properties, moisture and mold resistance, fire/thermal resistance and melt point, and handling/breakability. Further, the building products must not be uneconomical to produce.

By way of the present application, acoustical ceiling panels of mineral wool are disclosed that are free of formaldehyde, phenols and ammonia, can be made in significant part of recyclable materials and can be recycled at any stage of their life cycle, have excellent performance characteristics, and acceptable manufacturing costs.

### SUMMARY

In a first aspect, the present disclosure is directed to an acoustical ceiling panel comprising a core having a front face and a back face and comprising air laid mineral fibers and an aqueous binder. The aqueous binder comprises a first component in the form of one or more carbohydrates, and a second component in the form of one or more compounds selected from sulfamic acid, derivatives of sulfamic acid, and any salts thereof, ammonia and hypophosphorous acid. A formaldehyde-free first fleece having a thickness is secured to the front face of the core by powdered adhesive. A formaldehyde-free second fleece having a thickness is secured to the back face of the core by the aqueous binder. The thickness of the first fleece is greater than the thickness of the second fleece, and paint is applied to the first fleece. The acoustical ceiling panel has formaldehyde emissions of below 8 μg/m²/h of formaldehyde, preferably below 5 μg/m²/h, most preferably below 3 μg/m²/h, in accordance with ISO 16000 for testing aldehyde emissions.

In a second aspect, the first component of the binder is in the form of a glucose syrup having a Dextrose Equivalent of from 60 to less than 100 and a second component in the form of ammonium sulfamate and/or N-cyclohexyl sulfamic acid and/or its salts.

### BRIEF DESCRIPTION OF THE DRAWINGS

FIG. 1 is a perspective view of an acoustical ceiling panel according to the present application.

FIG. 2 is a diagrammatic illustration of a process for the manufacture of the ceiling panel of FIG. 1 up to the curing oven stage.

FIG. 3 is a diagrammatic continuation of FIG. 2 beyond the curing oven.

FIG. 4 is a table showing the results of transverse strength testing of specimens from two different tiles made according to the present disclosure.

FIG. 5 is a table showing the results of sag testing of two different tiles made according to the present disclosure.

### DETAILED DESCRIPTION

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

Mineral fiber products generally comprise man-made vitreous fibers (MMVF) such as, e.g., glass fibers, ceramic fibers, basalt fibers, slag wool, mineral wool and stone wool (rock wool), which are bonded together by a cured thermoset polymeric binder material. For use as thermal or acoustical insulation products, bonded mineral fiber mats are generally produced by blowing the fibers into a forming chamber and, while airborne and still hot, spraying with a binder solution and randomly depositing as a mat or web onto a travelling conveyor. The fiber mat is then transferred to a curing oven where heated air is blown through the mat to cure the binder and rigidly bond the mineral fibers together.

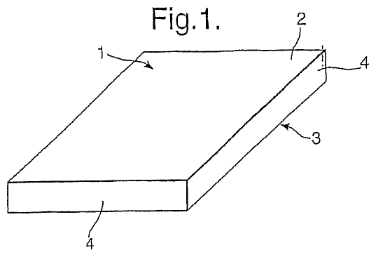

With reference to FIG. 1, a ceiling panel 1 is seen that has a sound-absorbing front face 2 extending in the XY plane, a rear face 3, and side edges 4 extending in the Z direction between the front and rear faces. The batts used in the ceiling panels are preferably manufactured as described in U.S. Pat. No. 7,779,964, incorporated herein by reference. In general terms, the batts are manufactured by collecting mineral fibers and binder entrained in air on a travelling collector and vertically compressing the collected fibers, optionally after cross-lapping, to form a web reorienting the fibers to provide unbonded batts having a density of 70 to 200 kg/m³, and having an increased fiber orientation in the Z direction.

The batts are then cured in an oven. Typically, the curing oven is operated at a temperature of from about 150° C. to about 350° C. Preferably, the curing temperature ranges from about 200° C. to about 300° C. Generally, the curing oven residence time is from 30 seconds to 20 minutes, depending on, for instance, the product density.

Then each batt is cut in the XY plane into two cut batts at a position in the Z dimension where the fibers have the increased orientation in the Z direction. The cut surfaces of the batts are smoothed by abrasion to produce a flat face.

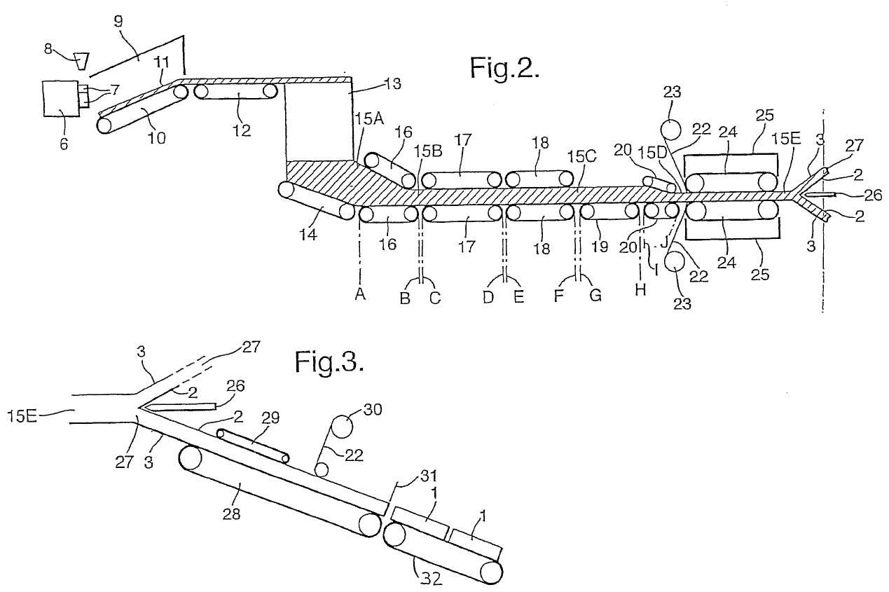

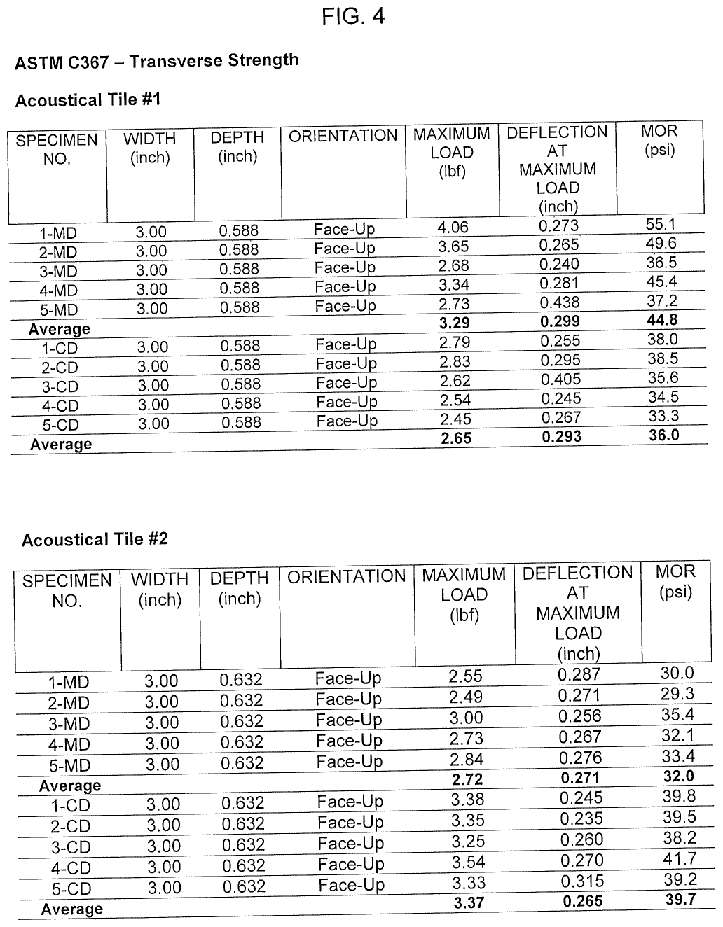

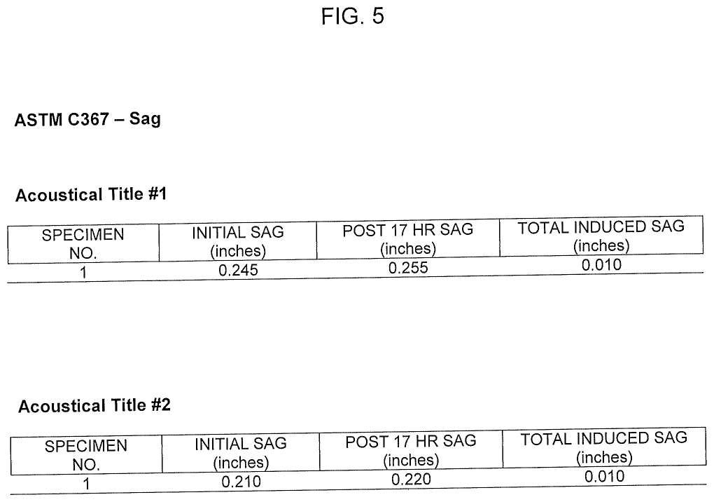

More specifically, a typical apparatus for making the product is shown in FIG. 2. The apparatus comprises a cascade spinner 6 having a plurality of rotors 7 mounted on the front face positioned to receive binder from a gutter 8, whereby binder which falls on to the rotors is thrown from one rotor to the next and from the rotors to the fibers. Present technology is to apply binder via a series of binder application nozzles arranged near the rotors, plus partly through central binder distributors in the rotors. The share of fibers is generally in the range of 95-98 wt % to 2-5 wt % binder. Additionally, minor amounts of oil are often added to achieve dust suppression and hydrophobic properties of the final product. The amount of oil added is generally 0.2-0.6 wt %.

The fibers/binder are entrained in air from in and around the rotors 7 whereby the fibers/binder are carried forward into a collecting chamber 9 having a perforated collector conveyor 10 in its base. Air is drawn through the collector and a web 11 forms on the collector and is carried out of the collecting chamber 9 and onto another conveyor 12. The primary web 11 is led by conveyor 12 into the top of a cross-lapping pendulum 13 by which layers of the primary web are cross-lapped on one another as they are collected as a secondary web 15A beneath the pendulum on conveyor 14.

The secondary web 15A is led by conveyor 14 to a pair of conveyors 16 for applying vertical compression to the secondary web from its natural depth, at point A, to its compressed depth at point B. The secondary web at point A has a weight per unit area of W.

The compressed secondary web 15B is transferred from point C to point D by conveyors 17. Conveyors 16 and 17 usually all travel at substantially the same speed so as to establish a constant speed of travel of the secondary web from the vertical compression stage AB to point D.

The web is then transported between a pair of conveyors 18 which extend between points E and F. Conveyors 18 travel much more slowly than conveyors 16 and 17 so that longitudinal compression is applied between points D and F.

Although items 14, 16, 17 and 18 are shown for clarity as conveyor belts spaced apart from one another in the Z direction, in practice they are normally very close to one another in the Z direction.

Points D and E are preferably sufficiently close to one another or are interconnected by bands, to prevent the secondary web escaping from the desired line of travel. As a result, substantial longitudinal compression has occurred when the web emerges at point F. Restraining guides can be provided, if necessary, between D and E to prevent break out of the web if D and E are not close together.

The resultant longitudinally compressed batt 15C is then carried along conveyor 19 between points G and H at a higher speed than by the conveyors 18. This applies some longitudinal decompression or extension to the longitudinally compressed web and prevents the web breaking out from the desired line of travel and, for instance, buckling upwards due to internal forces within the web. If desired or necessary, a conveyor or other guide (not shown) may rest on the upper surface of the batt (above conveyor 19) so as to ensure that there is no breakout.

When vertical compression is to be applied to the longitudinally compressed web, this is done by passing the web, after it leaves point H, between conveyors 20, which converge so as to compress the web vertically as it travels between the conveyors and points I and J.

The resultant uncured batt 15D may then be contacted on each outer face (which will become the backside of the finished panel) by a non-woven fleece material 22, described in greater detail below, from rolls 23. The backside fleece helps to retain the fibers in the batt, lower the amount of dust, and to provide better handling characteristics. The fleece passes through a bath of binder for bonding the fleece to the batt before the fleece is brought into contact with the batt. The resultant assembly then passes through a curing oven 25, where just sufficient pressure is applied by conveyors 24 to hold the sandwich of two layers of textile 22 and the batt 15D together while curing of the binder occurs. This sets the thickness of the batt and adheres the fleece to the backsides.

The bonded batt 15E emerges from the curing oven and is sliced centrally by a band saw 26 or other suitable saw into two cut batts 27, each having an outer face or backside 3 carrying the textile 22 and an inner cut face 2, which will become the front side of the panel.

With reference to FIG. 3, each cut batt 27 is supported on a conveyor 28 and travels beneath an abrading belt 29 where it is abraded or sanded to a flat configuration. A powdered adhesive is applied to the smooth surface 2 of the batt, and the batt is then heated so that the adhesive becomes tacky. A non-woven fleece material 22 is applied from roll 30. Heat and pressure are applied to cure the adhesive and to bond the fleece to the smooth surface 2, which will become the front side of the panel. The abraded or sanded cut batt 27 is then divided by appropriate cutters 31 into individual batts 1 which are carried away on conveyor 32. The resultant individual batts thus have a smooth, flat, sound absorbing front face extending in an XY plane, a rear face, and side edges extending in the Z direction between the front and rear faces, with a non-woven fleece applied to both the front and rear faces. The side edges may be square, or may have some other profile. Paint is preferably applied to the front side of the panel using spray or curtain techniques. Alternatively, the front fleece may be prepainted.

In keeping with one aspect of the present application, the binder is an aqueous-based composition formed of a first component one or more carbohydrates and a second component in the form of one or more compounds selected from sulfamic acid, derivatives of sulfamic acid, and any salt thereof. More specifically, the first component is in the form of a glucose syrup having a Dextrose Equivalent (DE) of 60 to less than 100 and the second component is in the form of ammonium sulfamate and/or N-cyclohexyl sulfamic acid and/or its salts, ammonia, and hypophosphorous acid. Such a binder is described in greater detail in US 2016/0177057, which is incorporated herein by reference.

The binder provides for a matt having improved mechanical strength, and an unexpectedly high mechanical strength when subjected to ageing conditions. The binder also provides for a comparatively high curing speed at a low curing temperature. The binder composition does not contain added formaldehyde and results in a mineral wool product that is “formaldehyde free,” meaning that the product has a measured formaldehyde emission factor of less than or equal to 8 μg/m^{2/}h at 24 elapsed exposure hours, preferably less than or equal to 5 μg/m^{2/}h at 24 elapsed exposure hours, and most preferably 3 μg/m^{2/}h at 24 elapsed exposure hours, as determined using the testing and measurement methodologies set forth in ASTM D 5116, UL 282, and the California Department of Public Health CDPH/EHLB/Standard Method V1.1 (CA Section 01350), and with reference to ISO 16000, Parts 6, 9 and 11.

In keeping with another aspect of the present application, the fleeces applied to the front and back faces of the batt comprise a formaldehyde-free nonwoven glass fiber material, comprising continuous filament glass fibers oriented in a random pattern and bonded together with a bio-based acrylic resin in a wet laid process. The fibers preferably have a nominal diameter of 6-13 μm and a nominal length of 8-18 mm. The fleeces has a nominal thickness of from 0.4-1.0 mm, while the front fleece has a nominal area weight of 50-180 g/m² (without paint), while the back fleece has a nominal area weight of 40-60 g/m². The fleeces have a Loss on Ignition (LOI) of from 15-30%. Preferably, the fleece applied to the front side of the batt is thicker and denser than the fleece applied to the backside in order to provide a better substrate for the paint that is applied thereto.

If enhanced sound blocking characteristics are desired, a high performance membrane having a lower air permeability may be applied to the backside of the batt in place of the backside fleece described above. In one embodiment the backside fleece may be made of wood pulp/glass fibers that are wet laid and chemically bonded with a styrene butyl acrylic. The rear fleece preferably has an air permeability that is lower than the front fleece to provide for better sound absorption.

In keeping with another aspect of the present application, the ceiling panels exhibit excellent acoustical properties. Acoustical performance is achieved by the panels being frictional sound absorbers in the frequency range of human hearing, approximately 20 Hertz to 20 Kilohertz. The sound absorption that is provided by the panels reduces noise levels and decreases reverberation, making rooms and spaces inside buildings more comfortable to occupy and verbal communication more accurate.

The excellent acoustical properties are achieved primarily due to the batts that form the panel core being made of thin, entangled, stone wool fibers, resulting in the structure of the entangled fibers forming the batt being porous, with many small air pockets existing in between the stone wool fibers. The entangled fibers also provide for a long and tortuous path through adjacent air pockets inside the batt. The moving air molecules in sound waves are able to enter the panels due to their porosity. As the surface of the air molecules interact with the surface of the fibers around the air pockets, the energy is converted from sound energy into heat energy through the process of friction.

The fleece applied to the front surface of the batt is for aesthetics only. The fleece, the adhesive used to laminate the fleece onto the surface of the batt and the process of laminating the fleece onto the matt are designed to ensure that the fleece is sound transparent, so that the sound energy incident to the panel can pass through the fleece and be absorbed by the batt. Specifically, the front fleece is secured to the batt by an adhesive to provide for better air permeability (and, consequently better sound absorption) than would be obtained if the if the front fleece were secured to the batt with the binder, as is the case with the back fleece. Similarly, the paint and the process of applying the paint to the fleece also has been designed to be sound transparent. The paint does not bridge over the open air pockets, allowing the sound energy to pass through the facing and be absorbed by the batt. The glass fleece accounts for 2 to 10 wt % and paint up to 15 wt % of the final product, with the share varying from one product type to the other depending on the demands for the specific product.

In keeping with another aspect of the application, the ceiling panels described herein have been verified as “Formaldehyde Free” by the Greenguard Environmental Institute (“GEI”) of Marietta, Ga., under GEI's low emitting product certification programs governed by GEI's ISO 65 Certification Body Accreditation. Consequently, formaldehyde exposure from such ceiling panels has been determined to not contribute to airborne formaldehyde at levels greater than those found in the natural outdoor environment.

Typical ceiling panels made in accordance with the description above have a thickness of from ½″ (13 mm) to 4″ (102 mm) and a density of from 70 kg/m³ to 165 kg/m³. Further, the panels may include recycled content of from up to 34% to up to 43%. Such panels exhibit the following performance characteristics:

### Declared Sound Absorption (NRC) ASTM C423: 0.6-1.05;

### Declared Sound Isolation (CAC) ASTM E1414: 22-43;

### Declared Speech Privacy (AC) ASTM E1111: 170-190;

### Fire Class per ASTM C1264: Class A;

### Required Flame/Smoke ASTM C1264: 25/50;

### Declared Flame/Smoke ASTM C1264 (E84): 0/0-5/0;

### Declared Flame/Smoke CAN ULC S102: 5/0-15/5;

### Light Reflectance (LR) ASTM E1477: 0.04-0.86;

### ASTM 1264 Classification: Type XX, Pattern E or G;

### Thermal Insulation R Value (BTUs) ASTM C518: 0.35-14; and

### Thermal Insulation RSI Value (Watts Units): 0.31-2.47.

Acoustical panels made in accordance with the description above have been tested in accordance with ASTM C367 (Standard Test Methods for Strength Properties of Prefabricated Architectural Acoustical Tile or Lay-In Ceiling Panels) for transverse strength and sag.

In testing for transverse strength, two different panels were tested. For each panel, ten 3 in. by 12 in. specimens were tested, five specimens being cut in a machine direction (“MD”) and five being cut in the cross direction (“CD”), with the specimens being supported at a span of 9 in. The specimens were loaded at a rate of 0.50 in/min until peak load was achieved. The results of the testing for transverse strength are shown in Table 1.

In testing for sag, two different panels were tested. For each panel, one 24 in. by 24 in. specimen was evaluated, with the specimen being positioned in a support frame and exposed to a conditioning for 17 hours at 23° C. and 50% relative humidity in standard laboratory conditions. The results of testing for sag are shown in Table 2.

Thus, an acoustical ceiling panel with improved environmental characteristics has been provided without compromise of the performance characteristics and that is also economical to produce. It will be understood that the embodiment described above is illustrative of the present subject matter, and that modifications may be made by those skilled in the art, including combining features that are individually disclosed or claimed herein. Accordingly, the scope of the invention is not limited to the description above, but is set forth in the following claims

1. An acoustical ceiling panel comprising:
a) a core having a front face and a back face and comprising air laid mineral fibers and an aqueous binder, the aqueous binder comprising a first component in the form of one or more carbohydrates, and a second component in the form of one or more compounds selected from sulfamic acid, derivatives of sulfamic acid, and any salts thereof, ammonia and hypophosphorous acid;
b) a formaldehyde-free first fleece having a thickness and secured to the front face of the core by powdered adhesive;
c) a formaldehyde-free second fleece having a thickness and secured to the back face of the core by the aqueous binder, the thickness of the first fleece being greater than the thickness of the second fleece; and
d) paint applied to the first fleece;
e) wherein the acoustical ceiling panel has formaldehyde emissions of below 8 μg/m²/h of formaldehyde, preferably below 5 μg/m²/h, most preferably below 3 μg/m²/h.

2) The acoustical ceiling panel of claim 1 wherein the first component of the binder is in the form of a glucose syrup having a DE of from 60 to less than 100 and a second component in the form of ammonium sulfamate and/or N-cyclohexyl sulfamic acid and/or its salts.
